(19) United States
(12) Patent Application Publication
(10) Pub. No.: US 2009/0157670 A1
(43) Pub. Date: Jun. 18, 2009

(54) CONTENTS-RETRIEVING APPARATUS AND METHOD

(76) Inventors: Kentaro MIYAMOTO, Tokyo (JP); Yuko Matsui, Tokyo (JP)

Correspondence Address: BIRCH STEWART KOLASCH & BIRCH, PO BOX 747, FALLS CHURCH, VA, 22040-0747, US

(21) Appl. No.: 12/336,042

(22) Filed: Dec. 16, 2008

(30) Foreign Application Priority Data
Dec. 17, 2007 (JP) 2007-324499

(51) Int. Cl. G06F 17/30

(52) U.S. Cl. 707/5; 707/E17.02

(57) ABSTRACT

An image database stores data of variable images as contents, and at least a keyword is attached to each image. A degree of relevancy between every pair of keywords of the images stored in the image database is calculated at constant time intervals, to produce time-sequential data on inter-keyword relevancy of each pair. When a search keyword entered, a basic relevancy is calculated by smoothing the time-sequential data on the inter-keyword relevancy between the search keyword and a keyword that is attached to an image extracted on the basis of the search keyword. If other keywords are attached to the extracted image, a total relevancy of the extracted image is calculated by averaging the basic relevancies of the respective keywords of the extracted image to the search keyword. Among many extracted images, those having higher relevancies to the search keyword are output as a search result.

### FIELD OF THE INVENTION

The present invention relates to a contents-retrieving apparatus and a contents-retrieving method, whereby expected contents, such as image files or music data files, are being retrieved from a database storing huge amount of contents on the basis of arbitrarily entered search keywords.

### BACKGROUND OF THE INVENTION

Recently, databases storing a variety of contents such as text data, image data and music data are disclosed through communication networks like the Internet, so the users can register some contents on the database or search the database for favorable contents and download them by operating personal computers or mobile terminals, which are connected to the communication network.

As a method for retrieving expected contents from the database, “search based on keyword” is general. This is a method, wherein such a keyword or keywords that have some relation to the expected contents are entered so as to find out those contents which contain or relate to the entered keyword or keywords. Since it is unnecessary to categorize the contents in the database, the search based on keyword simplifies the management of the database and improves availability of an enormous number of contents from the database.

In the case where an enormous number of contents are stored in the database, it often occurs with some keyword that the number of contents hit by the keyword is so large that the users cannot easily find out their expecting contents. As a solution for this problem, so-called narrowed search has been known, wherein the contents hit by the first keyword are winnowed by entering another keyword, and winnowed more and more by entering additional keywords.

Because the user is required to think of the keyword to enter for the narrowed search, if the entered keyword is irrelevant, the contents will be insufficiently winnowed or some relevant contents will be wrongly winnowed out. To solve this problem, a prior art for supporting the user on searching has been suggested for example in JPA 2003-108594. In this prior art, histories of narrowed search with past keywords are memorized, so that those keyword which have relation to a newly entered keyword are retrieved from the past keywords and are offered to the user.

However, according to the conventional search technique, the search result varies depending upon the search histories of all users as well as the search history of the present user, so the search result is influenced by the trend of the times or the period or season when the search is carried out. That means, such contents that definitely reflect the trend of the times will be hit more frequently. For example, as for a search based on a keyword “Mt. Fuji”, if it is carried out in summer, the search result will include a larger number of such contents that relate also to “Climbing”. On the contrary, if the search with the keyword “Mt. Fuji” is carried out in winter, such contents that relate also to “Climbing” will be scarcely retrieved.

Getting such search result has no problem if the user wants to get such contents that are in tune with the times or reflect the trend of the times. However, if the user wants to get such contents that relate to basic information on the entered keyword, it can be difficult to retrieve expected contents in the conventional search method, because of the influence of the trend of the times on the search result.

### SUMMARY OF THE INVENTION

In view of the foregoing, a primary object of the present invention is to provide a contents-retrieving apparatus and a contents-retrieving method, which allow the user to cut off the influence of the trend of the times from the search result and retrieve proper contents while taking account of the influence of the trend of the times.

In a contents-retrieving apparatus for retrieving some contents from a database, which stores variable contents with their respective keywords attached thereto, on the basis of an entered search keyword, the present invention comprises an inter-keyword relevancy calculator for calculating an inter-keyword relevancy between every pair of keywords attached to contents as stored in the database at constant time-intervals to produce time-sequential data on the inter-keyword relevancy of every pair of keywords; a basic relevancy calculator for calculating a basic relevancy of a particular keyword to the search keyword by smoothing the time-sequential data on the inter-keyword relevancy between the search keyword and the particular keyword; a contents-extracting device for extracting at least a content from the database on the basis of the search keyword; a judging device for making a judgment as to whether the extracted content should be included in a search result, on the basis of the basic relevancy between the search keyword and a keyword which is attached to the extracted content; and an outputting device for outputting the search result.

Preferably, the basic relevancy calculator smoothes the time-sequential data on the inter-keyword relevancy by moving average.

The inter-keyword relevancy calculator calculates the relevancy between each pair of keywords on the assumption that those keywords which are attached to the same content have some relation to each other.

Preferably, the contents-retrieving apparatus further comprises a total relevancy calculator for calculating a total relevancy of a content to the search keyword when a plurality of keywords are attached to the content, the total relevancy calculator calculating the total relevancy by averaging the basic relevancies between the search keyword and the respective keywords attached to the content, wherein the result judging device judges the extracted content by its total relevancy.

Preferably, the result judging device judges those contents, of which total relevancy is greater than a predetermined value, to be included in the search result.

The contents-extracting device preferably extracts those contents which are attended by the search keyword from the database, and the basic relevancy calculator calculates the basic relevancies with respect to the extracted contents.

A contents-retrieving method for retrieving some contents from a database on the basis of an entered search keyword, wherein the database stores variable contents with their respective keywords attached thereto, the contents-retrieving apparatus comprising steps of:

calculating an inter-keyword relevancy between every pair of keywords attached to the contents as stored in the database at constant time-intervals to produce time-sequential data on the inter-keyword relevancy of every pair of keywords; calculating a basic relevancy of a particular keyword to the search keyword by smoothing the time-sequential data on the inter-keyword relevancy between the search keyword and the particular keyword; extracting at least a content from the database on the basis of the search keyword; making a judgment as to whether the extracted content should be included in a search result on the basis of the basic relevancy between the search keyword and a keyword which is attached to the extracted content; and outputting the search result.

Since the relevancy of each content to the search keyword is determined on the basis of the basic relevancies, which are calculated by smoothing the time-sequential data and thus less influenced by the trend of times, the contents-retrieving apparatus and method of the present invention allow the user to cut off the influence of the trend of the times from the search result and retrieve proper contents while taking account of the influence of the trend of the times

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a schematic diagram illustrating a network system for retrieving image data from a server;

FIG. 2 is a functional block diagram illustrating an interior of a client's terminal of the network system;

FIG. 3 is a functional block diagram illustrating an interior of the server;

FIG. 4 is a data table correlating image files to their respective keywords;

FIG. 5 is a schematic diagram illustrating an example of an image attended by keywords;

FIG. 6 is a graph illustrating time-sequential data on inter-keyword relevancies and smoothed time-sequential data;

FIG. 7 is a table showing an example of basic relevancies and momentary relevancies between a search keyword and other keywords attached to the image of FIG. 5;

FIG. 8 is a flowchart illustrating a sequence of processing in the client's terminal;

FIG. 9 is a flowchart illustrating a sequence of processing in the server;

FIG. 10 is a schematic diagram illustrating an example of a search command screen displayed on a monitor of the client's terminal;

FIG. 11 is a schematic diagram illustrating an example of a search result display screen displayed on the monitor of the client's terminal;

FIG. 12 is a schematic diagram illustrating a variation of a search command screen displayed on the monitor of the client's terminal;

FIG. 13 is a schematic diagram illustrating a variation of a search result display screen displayed on the monitor of the client's terminal; and

FIG. 14 is a table showing another example wherein weighting coefficients are allocated to the respective keywords as attached to one image.

### DESCRIPTION OF THE PREFERRED EMBODIMENTS

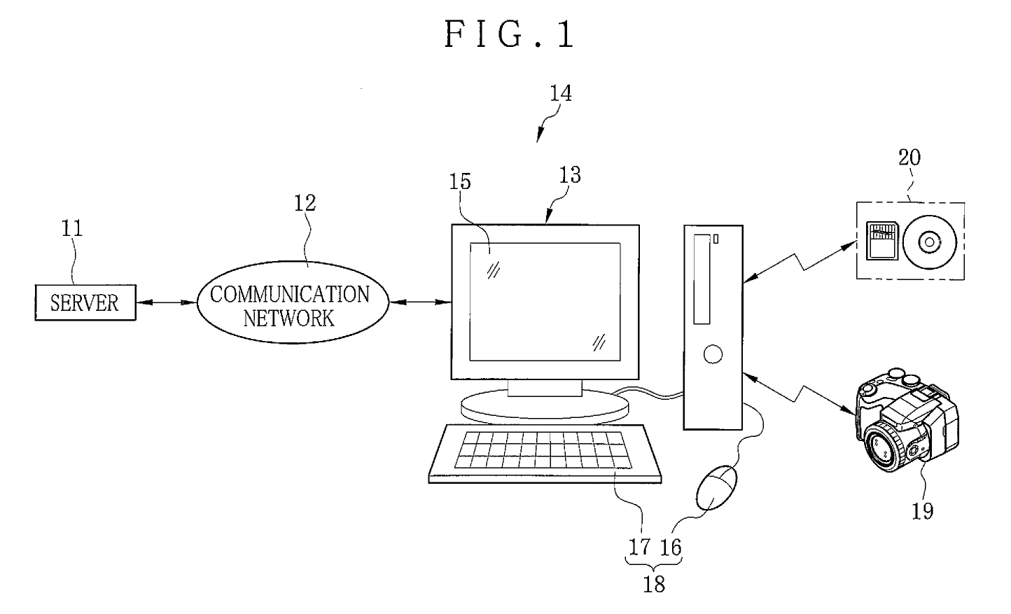

In FIG. 1, a contents-retrieving apparatus as an embodiment of the present invention is incorporated in a server 11 by installing a program that is recorded in a recording medium. The following description will be based on an exemplar where image data are retrieved as the contents. Hereinafter, the image data will be referred to simply as images.

The server 11 is connected to clients' terminals 13 via a communication network 12, to constitute a network system 14. Each client's terminal 13 is constituted of a well-known personal computer, which is provided with a monitor 15 for displaying various operational screens and operating devices 18 comprising a mouse 16 and a keyboard 17. Search keywords for image-retrieval are input through the keyboard 17.

The client's terminal 13 takes images captured by a digital camera 19 or images recorded on a recording medium 20 such as a memory card or a CD-R. These images have respective keywords attached as their tags. The tag is attached to every image by operating the operating devices 18 as the image is taken into the client's terminal 13.

The digital camera 19 is connected to the client's terminal 13 through a communication cable like an USB (universal serial bus) cable or a wireless line like a wireless LAN, so that the digital camera 19 can exchange data with the client's terminal 13.

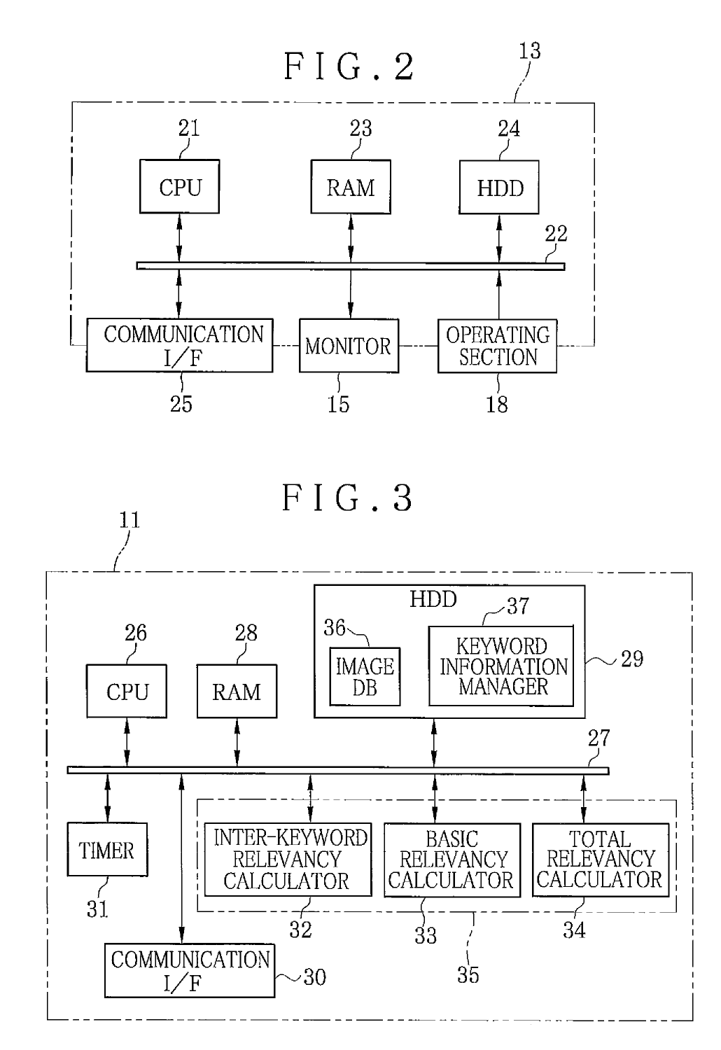

Referring to FIG. 2 showing functional blocks of the client's terminal 13, a CPU 21 controls the overall operation of the client's terminal 13 according to operational signals and the like as input through the operating devices 18. A data bus 22 connects the CPU 21 to a RAM 23, a hard disc drive (HDD) 24 and a communication interface (I/F) 25 as well as the monitor 15 and the operating devices 18.

The RAM 23 is a work memory for the CPU 21 to execute various processing. The HDD 24 stores various programs and data served for the work of the client's terminal 13 as well as the images taken from the digital camera 19 and the recording media 20. The CPU 21 reads out the program from the HDD 24 and develops it in the RAM 23 to execute a process based on the program.

The 25 controls a communication protocol that is suitable for the communication network 12, and mediates the data-exchange through the communication network 12. The 25 also mediates the data-exchange between the client's terminal 13 and external instruments such as the digital camera 19 and the recording media 20.

Referring to FIG. 3 showing functional blocks of the server 11, a CPU 26 controls the overall operation of the server 11 according to operational signals input through the clients' terminals 13 via the communication network 12. The CPU 26 is connected via a data bus 27 to a RAM 28, a hard disc drive (HDD) 29, a communication interface (I/F) 30, a timer and a relevancy calculator 35 that consists of an inter-keyword relevancy calculator 32, a basic relevancy calculator 33 and a total relevancy calculator 34.

The RAM 28 is a work memory for the CPU 26 to execute various processing. The HDD 29 stores various programs and data served for the work of the server 11. The CPU 26 reads out the program from the HDD 29 and develops it in the RAM 28 to execute a process based on the program. Note that the relevancy calculator 35 is a functional block that is constituted of a program stored in the RAM 28.

The communication I/F 30 controls a communication protocol that is suitable for the communication network 12, and mediates the data-exchange through the communication network 12. The data taken through the communication I/F 30 is stored temporarily in the RAM 28. If an image is taken as the data, it is stored in the HDD 29.

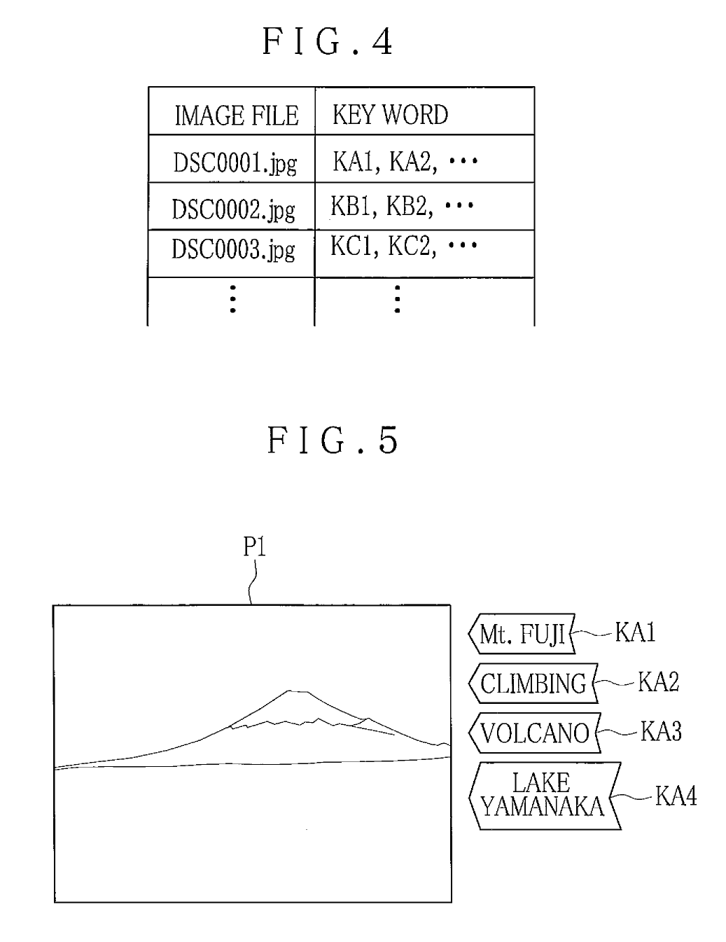

In the HUD 29, an image database (DB) 36 and a keyword information manager 37 are incorporated. The image database 36 stores images taken via the communication network 12 and the keywords attached to the images in association with each other. As shown in FIG. 4, the images and the keywords are associated with each other in the form of a data table. Note that additional keywords may be attached to any image stored in the image DB 36 or the attached keywords may be deleted from any image stored in the image DB 36.

FIG. 5 shows an example of an image P1 stored in the image DB 36 and keywords attached to this image P1. The image P1 is a photograph of the Mt. Fuji, so four keywords KA1, KA2, KA3 and KA4, “Mt. Fuji”, “Climbing”, “Volcano” and “Lake Yamanaka”, are associated with this image P1.

The keyword information manager 37 stores time-sequential data of such information that show the degree of relevancy between two keywords which are attached to the same image as registered in the image DB 36. The degrees of relevancy between the keywords are obtained by the inter-keyword relevancy calculator 32. The inter-keyword relevancy calculator 32 refers to the keywords attached to each image, and calculates the degree of relevancy between each pair of keywords which are attached to the same image, on the assumption that the keywords attached to the same image have some relation to each other. It means that the inter-keyword relevancy Rt between two keywords gets greater as the number of such images that are attended by these two keywords increases in the image database 36. Then the inter-keyword relevancy calculator 32 systematizes the calculated inter-keyword relevancies to build up a thesaurus in the keyword information manager 37.

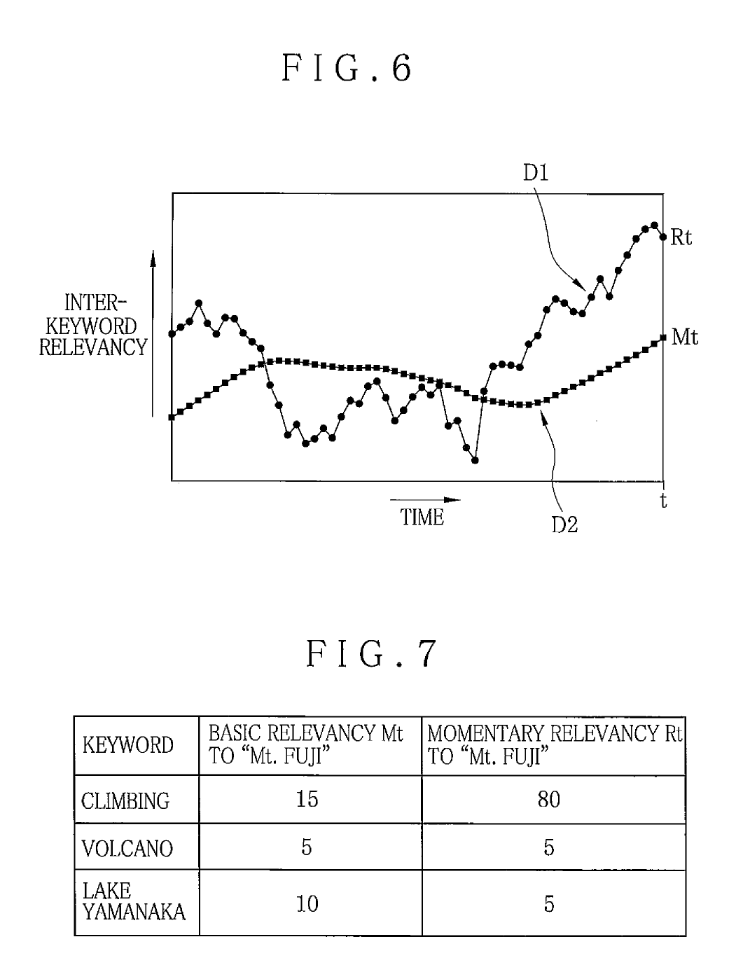

The CPU 26 activates the inter-keyword relevancy calculator 32 periodically, e.g. once a day, on the basis of the time counted by the timer 31, to revise or restructure the thesaurus periodically and obtain time-sequential data D1 on the relevancy between every pair of keywords, as shown in FIG. 6. The time-sequential data D1 shows the inter-keyword relevancy Rt at a time “t” in a time sequential fashion. The inter-keyword relevancy Rt shows the degree of relevancy between a pair of keywords, e.g. “Mt. Fuji” and “Climbing” at a particular moment. If the inter-keyword relevancy Rt between two keywords is high at the time when the search is executed, it means that a large number of such images that are attended by these two keywords are stored in the image database 36 at that time.

When the CPU 26 receives a search command from the client's terminal 13, the CPU 26 searches the image DB 36 for those images associated with a keyword input on the client's terminal 13, hereinafter called the search keyword. Then, the CPU 26 activates the data bus 22 and the RAM 23 to execute a narrowed search, winnowing the extracted images. So the CPU 26 functions as a contents-extracting device. The basic relevancy calculator 33 makes a filtering process or smoothing process of the time-sequential data D1 with respect to the relevancy Rt between the input search keyword and any other keyword attached to the extracted images, to calculate a basic relevancy Mt of the individual keyword to the search keyword. The basic relevancy Mt is expressed as a smoothed time-sequential data D2, as shown in FIG. 6, and represents a basic degree of relevancy between a pair of keywords, which is less influenced by the trend of the times.

Concretely, the basic relevancy Mt at a particular time “t” is obtained by calculating an average of the inter-keyword relevancies Rt obtained in a period T, e.g. thirty days, right before the particular time “t”, using a method called moving average. Provided that “N” and “ΣRt” respectively represent the number and the sum of the keyword relevancies Rt obtained in the period T, the basic relevancy Mt is expressed by an equation: Mt=ΣRt/N. Since the relevancy Rt before the filtering depends upon the times, this value Rt will be called “momentary relevancy” in contrast with the basic relevancy Mt.

The total relevancy calculator 34 calculates a total relevancy St of each individual extracted image to the search keyword. The total relevancy calculator 34 calculates the total relevancy St on the basis of either the basic relevancies Mt or the momentary relevancies Rt between the search keyword and other keywords attached to the extracted image. Whether the basic relevancies Mt or the momentary relevancies Rt are to be used for calculating the total relevancy St can be designated on the client's terminal 13 at the start of searching.

According to the present embodiment, the total relevancy calculator 34 calculates the total relevancy St of each image as an average AMt of the basic relevancies Mt or an average ARt of the momentary relevancies Rt. Concretely, in a case where “Mt. Fuji” is input as a search keyword, and the above-mentioned image P1 is extracted, the basic relevancies Mt and the momentary relevancies Rt between the search keyword “Mt. Fuji” KA1 and other keywords KA2 to KA4 can be as shown in FIG. 7. In this case, AMt=(15+5+10)/3=10, whereas ARt=(80+5+5)/3=30. That is, the total relevancy St of this image P1 to the search keyword “Mt. Fuji” will be greater in this case when it is based on the momentary relevancies Rt than when it is based on the basic relevancies Mt, because of the influence of the keyword “Climbing”, of which the relevancy to the search keyword “Mt. Fuji” varies pretty much depending on the times.

The CPU 26 compares the total relevancy St of each of the extracted images with a predetermined value, and sends information on those images, of which the total relevancy St is greater than the predetermined value, to the client's terminal 13 via the communication network 12. The information on the images, including their image data and file names, is displayed as a search result on the monitor 15 of the client's terminal 13.

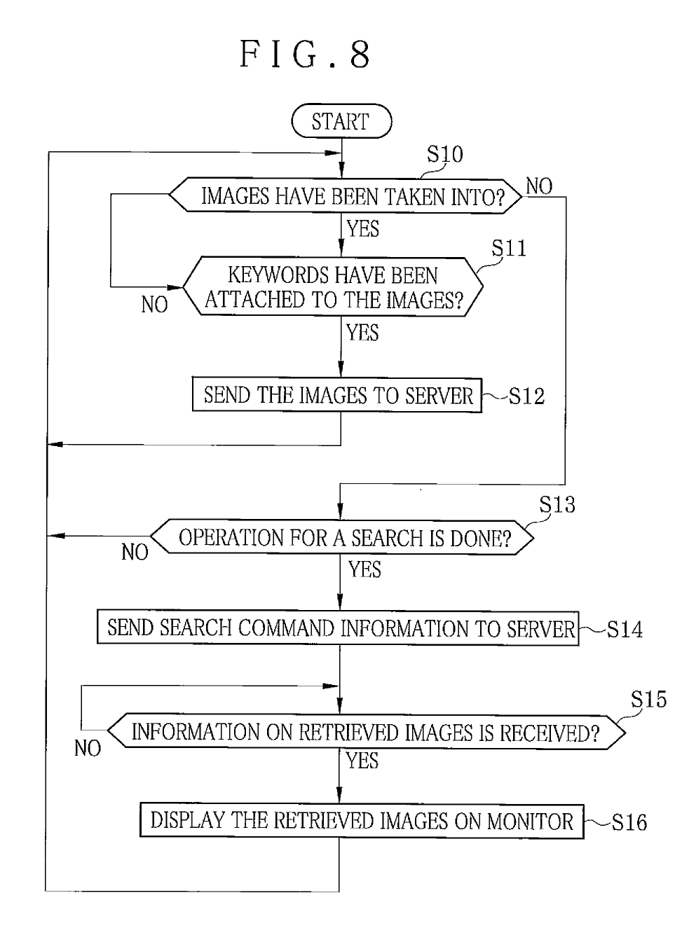

Now the operation of the network system 14 having the above construction will be described. FIG. 8 shows a sequence of processing in the client's terminal 13. In the first step S10, the digital camera 19 or the recording medium 20 is connected to the client's terminal 13, and the client's terminal 13 checks if images stored in the external device 19 or 20 have been taken into the client's terminal 13. When completing taking the images, the client's terminal 13 checks if any keywords are attached to the images through the operating devices 18 in the next step S11. When some keywords have been attached to the image or are already attached to the images, the images with the keywords are sent to the server 11 through the communication network 12 in the step S12. It is also possible to send the images in response to a user's command for sending them after waiting for this command. The images received on the server 11 are stored in the image database 36 in the HDD 29.

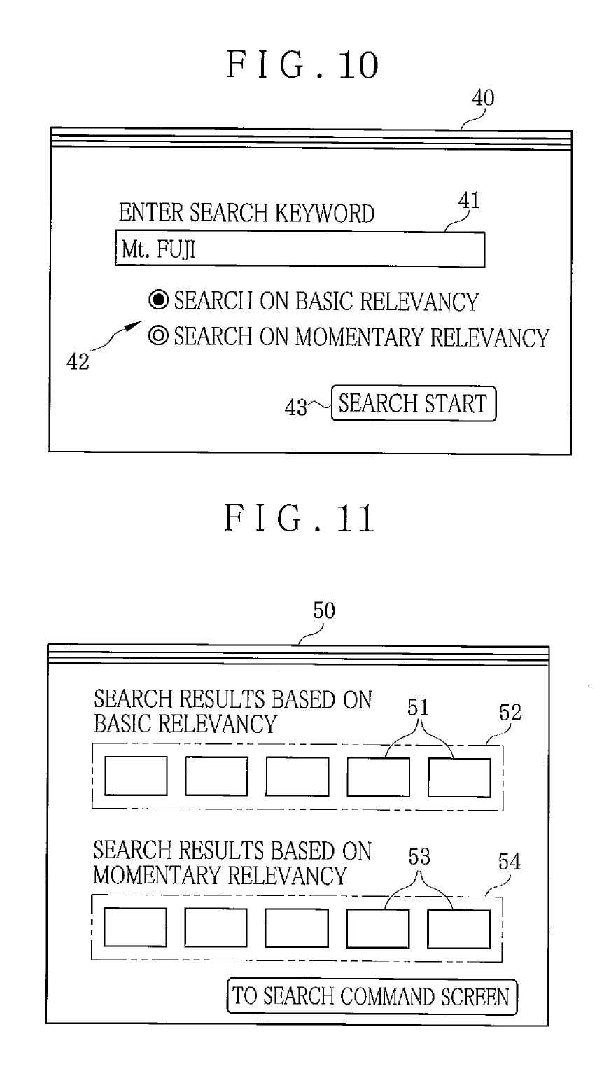

When the images have been sent from the client's terminal 13 to the server 11 in the step S12, the sequence gets back to the step S10. If it is judged that any images are not taken into in the step S10, the client's terminal 13 checks if a searching operation is done for retrieving some images from the image DB 36 of the server 11. The searching operation may be done through the operating devices 18 while watching a search command screen 40 displayed on the monitor 15, like as shown in FIG. 10. On the search command screen 40 are displayed a keyword entry box 41 for entering a search keyword, radio buttons 42 for alternative choice between the search based on basic relevancy and the search based on momentary relevancy, and a search start button 43 for executing a search process. As will be described in detail later, the basic relevancy search is based on the basic relevancy Mt that is less influenced by the trend of the times, whereas the momentary relevancy search is based on the momentary relevancy Rt that is influenced by the trend of the times.

When the search command is given in the step S13, the client's terminal 13 sends search command data, including the search keyword and information on the choice between the basic relevancy search and the momentary relevancy search, to the server 11 in the step S14. In response to the search command data, the server 11 executes an image retrieval process as set forth later. In the next step S15, the client's terminal 13 checks whether it receives any image information, such as image data and file names of the retrieved images, as a search result from the server 11. When the image information is received, the client's terminal 13 displays the search result on the monitor 15 on the basis of the image information in the step S16. After the step S16 is terminated, the sequence goes back to the step S10.

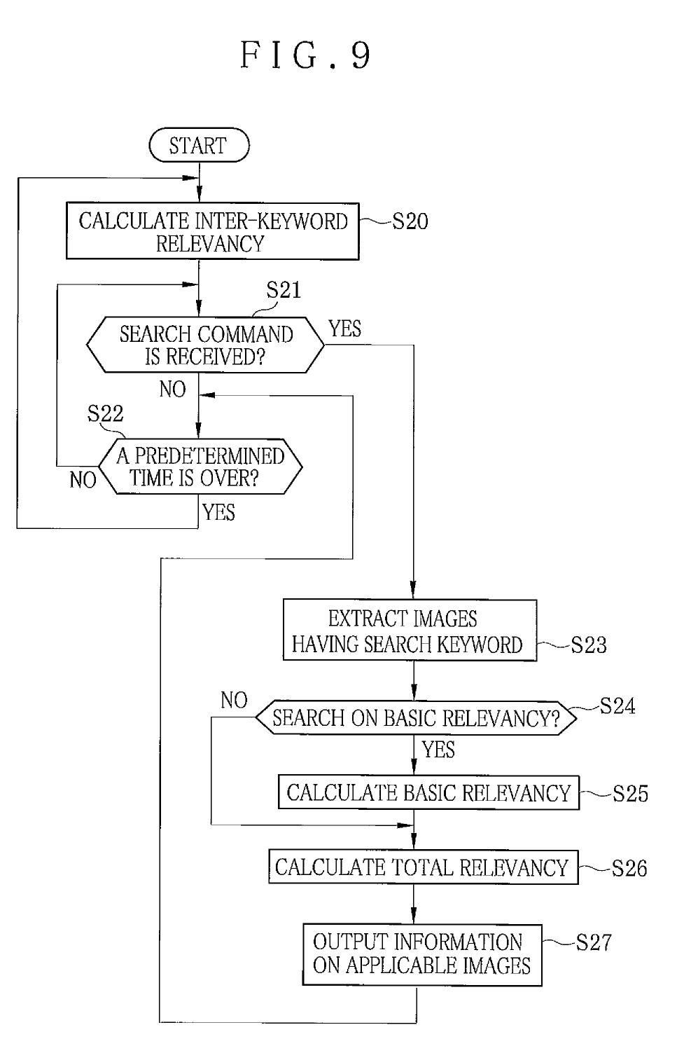

FIG. 9 shows a sequence of processing in the server 11. In the first step S20, the inter-keyword relevancy calculator 32 refers to the individual keywords attached to the respective images as stored in the image DB 36, and calculates the momentary relevancy Rt between each pair of those keywords which are attached to the same image. Taking the image P1 of FIG. 5 for example, the inter-keyword relevancy calculator 32 counts “1” for each pair of the keywords, such as “Mt. Fuji” and “Climbing”, “Climbing” and “Volcano” etc. If the keyword pair “Mt. Fuji” and “Climbing” is attached to another image among those stored in the image DB 36, the inter-keyword relevancy calculator 32 counts up one increment for this pair, so the momentary relevancy Rt between “Mt. Fuji” and “Climbing” gets to “2”. In the same way, the momentary relevancy Rt is calculated for each pair of all keywords of the images stored at the time of searching “t” in the image DB 36.

After the step S20, the server 11 checks if it receives the search command data that is sent from the client's terminal 13 in the step S14. This step S21 is made repeatedly till a predetermined time, e.g. 24 hours, is judged to have passed in the next step S22. When it is judged in the step S22 that the predetermined time has passed, the server 11 gets back to the step S20 to calculate relevancy between keywords. This way, the step S20 is repeated at the predetermined intervals, so the time-sequential data D1 showing the inter-keyword relevancy in a time-sequential fashion is provided, as shown in FIG. 6.

When it is judged in the step S21 that the client's terminal 13 receives the search command information from the server 11, the sequence proceeds to the next step S23, wherein the CPU 26 extracts from among the images stored in the image DB 36 those images which are attended by the search keyword received as the search command information. For example, when the search keyword is “Mt. Fuji”, such images as shown in FIG. 6 are extracted.

When the step S23 is complete, it is judged by the search command information in the step S24 which is chosen the basic relevancy search or the momentary relevancy search. When the basic relevancy search is chosen, the sequence proceeds to the step S25, wherein the basic relevancy calculator 33 calculates the basic relevancies Mt between the search keyword and other keywords, which are attached to the images as extracted in the step S23. That is, the time-sequential data D1 of the momentary relevancy Rt of another keyword to the search keyword is subjected to a filtering or smoothing process to get the basic relevancy Mt between them. As shown for example in FIG. 6, the basic relevancy Mt is obtained as smoothed time-sequential data D2 through moving average of the time-sequential data D1. In the case of the image P1, the basic relevancies Mt to the search keyword at the time “t” of searching are calculated to be as shown in FIG. 7. If the search based on momentary relevancy is chosen, the step S25 is skipped, and the sequence proceeds from the step S24 to the step S26.

In the step S26, the total relevancy calculator 34 calculates the total relevancies St of the extracted images to the search keyword on the basis of the basic relevancies Mt or the momentary relevancies Rt. That is, when the search based on basic relevancy is chosen, the total relevancy calculator 34 calculates the total relevancy St of each image as an average AMt of the basic relevancies Mt between the search keyword and other keywords attached to that image. Whereas when the search based on momentary relevancy is chosen, the total relevancy calculator 34 calculates the total relevancy St as an average ARt of the momentary relevancies Rt between the search keyword and other keywords attached to that image. As for the example shown in FIG. 7, the total relevancy St=AMt=(15+5+10)/3=10 in the basic relevancy search, whereas St=ARt=(80+5+5)/3=30 in the momentary relevancy search.

In the following step S27, the CPU 26 compares the total relevancy St of each image with a predetermined threshold value, to sort out only those images, of which total relevancies St are greater than the threshold value. Then, information on the sorted images is sent to the client's terminal 13, so the client's terminal 13 displays the received information on the retrieved images as a search result on the monitor 15 (step S16).

As for the image P1, the degree of relevancy to the search keyword “Mt. Fuji” gets higher in summer because of its another keyword “Climbing”, so the probability of hitting this image P1 is higher in summer when the search based on momentary relevancy is chosen for the image searching. On the contrary, through the search based on basic relevancy, the probability of hitting this image P1 is relatively low in summer. This means that the user should choose the basic relevancy search if it is desirable to reduce the influence of the times from the search result. Then the user gets more likely to obtain expected images while eliminating such images that are certainly under the influence of the trend of the times.

In the above embodiment, the basic relevancy Mt is calculated by smoothing through moving average of the relevancies Rt as calculated by the inter-keyword relevancy calculator 32 in a predetermined period. The period of moving average may also be designated by the user on the client's terminal 13. Thereby, the user can adjust the degree of smoothing, i.e. the degree of reducing the influence of the time from the search result.

Other kinds of smoothing processes than the moving average are usable for calculating the basic relevancy Mt. For example, frequency analysis such as Fourier transformation is also usable. It is also possible to use a low-pass filter to obtain the most frequent value of the relevancies Rt as the basic relevancy (a constant value) Mt. Of course, it is also possible to allow the user to input a calculation period for the alternative method on the client's terminal 13.

Although the value calculated by the inter-keyword relevancy calculator 32 is directly used as the momentary relevancy Rt in the above embodiment, the momentary relevancy Rt may be calculated by smoothing the time-sequential data D1 for a shorter period than that applied to the basic relevancy Mt. The momentary relevancy Rt may also be calculated by subtracting the basic relevancy Mt from a value calculated by the inter-keyword relevancy calculator 32.

Although the above embodiment calculates the total relevancy St based on either the basic relevancy Mt or the momentary relevancy Rt, it is possible to calculate the total relevancy St based on both the basic relevancy Mt and the momentary relevancy Rt, using a coefficient α (0≦α≦1): St−αMt+(1−α)Rt. For example, α=0.9 for the search based on the basic relevancy, whereas α=0.1 for the search based on the momentary relevancy. This coefficient a may be designated by the user on the client's terminal 13.

In the above embodiment, information on those images, of which total relevancies St are greater than the threshold value, is sent as the search result to the client's terminal 13. However, it is possible to send information on a predetermined number of images, of which the total relevancy St to the search keyword is in the top. It is also possible that the user may designate the threshold value of the total relevancy or the number of retrieved images as a search criterion on the client's terminal 13.

In the above embodiment, the user alternatively chooses between the search based on the basic relevancy and the search based on the momentary relevancy. Instead of this, the present invention may be so configured that the user can execute the search based on the basic relevancy and the search based on the momentary relevancy simultaneously. In that case, respective results of these two kinds of searches should be displayed distinguishably from each other on the client's terminal 13. For example, as shown in FIG. 11, a search result display screen 50 is partitioned into a display area 52 for those images 51 which are retrieved by the search on basic relevancy and a display area 54 for those images 53 which are retrieved by the search on momentary relevancy. In the individual display areas 52 and 54, the images are preferably arranged in a sequence from one of the highest total relevancy St to the lower one. But if the result of the search on the basic relevancy contains the same image as the result of the search on the momentary relevancy, the same image may be displayed only in one display area 52 or 54, taking account of its total relevancy St.

In the above embodiment, those images are extracted from the image DB 36, which are attended by a search keyword as entered by the user, and then the narrowed search is done based on relevancies of other keywords of the extracted images to the entered search keywords. Instead of this, relevancy (total relevancy St) to an entered search keyword may be calculated with respect to every image in the image DB 36 while calculating relevancies between the search keyword and individual keywords or a representative keyword of every image based on the thesaurus that is built in the keyword information manager 37, so as to retrieve such images that are highly relevant to the search keyword. Since the search process using the thesaurus covers those images which are not attended by the entered search keyword as search targets, so-called fuzzy search is available.

Although the above embodiment enters only one word as a search key, it is possible to use more than one keyword as search keywords for a search process. In that case, those images which are attended by these search keywords are extracted from the image DB 36, and the narrowed search is done based on relevancies of other keywords of the extracted images to the respective search keywords. For the sake of the above-mentioned fuzzy search using the thesaurus, the search process is done based on relevancies between the respective search keywords and individual keywords or a representative keyword of each image in the image DB 36. Where more than one search keyword is used for a search process, relevancies (basic relevancies Mt and momentary relevancies Rt) of all keywords of each image to the respective search keywords are averaged to calculate a total relevancy St of each image.

In the above embodiment, a search keyword is entered as a text through the keyboard 17. Instead of this, it is possible to display several keywords on a list, so that the use may designate a search keyword by choosing one from among the displayed ones.

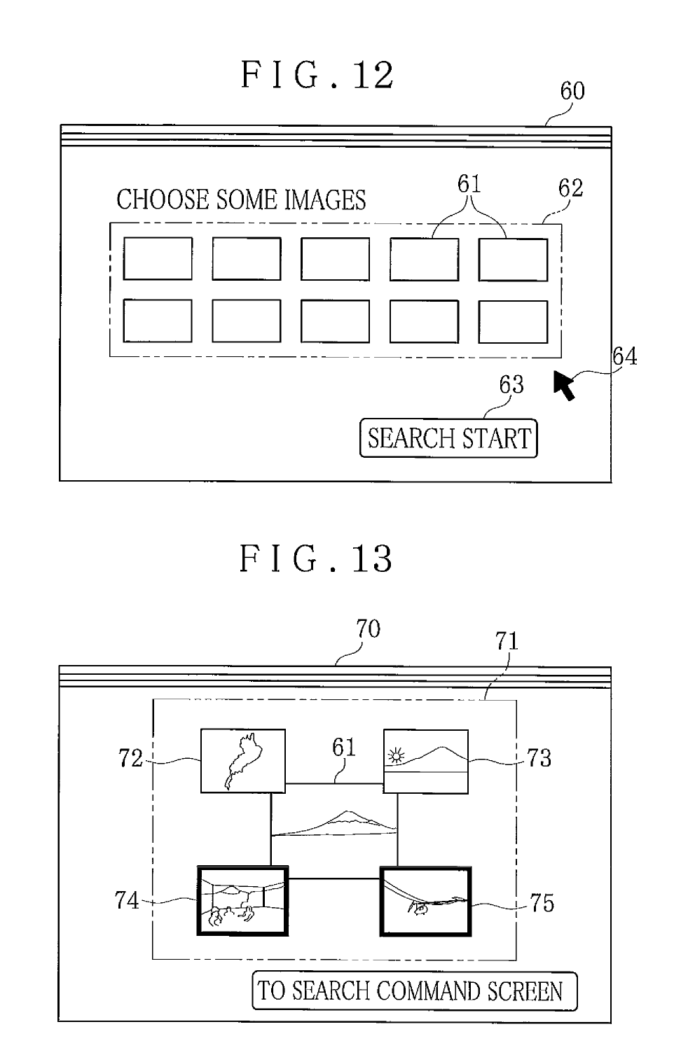

It is also possible to enter a search keyword by designating an image among several candidates, wherein each of the candidate images are attended by a keyword or keywords. As shown for example in FIG. 12, a search command screen 60 is provided with an image display area 62 for displaying the candidate images 61 and a search start button 63, though any radio buttons for choosing between the search on basic relevancy and the search on momentary relevancy. The user chooses one of the displayed images 61 by a mouse pointer 64 and clicks on the search start button 63, so a search command is entered. In that case, a keyword or keywords attached to the chosen image 61 are used as the search keyword or keywords for retrieving images from the image DB 36. In this embodiment, the search command screen 60 and the operating devices 18 function as a search command input device.

FIG. 13 shows an example of a search result display screen in the embodiment using an image as a search key. The search result display screen 70 is provided with an image display area 71, which displays the image 61 that has been designated to be the search key on the search command screen 60, and images 72, 73, 74 and 75 as search results. The image 61 is displayed in the center of the image display area 71, and those images 72 and 73 having high basic relevancy Mt to the image 61 are displayed on upper margins of the image 61, whereas those images 74 and 75 having high momentary relevancy Rt to the image 61 are displayed on lower margins of the image 61. To make the images 74 and 75 distinguishable from the images 72 and 73, the images the images 74 and 75 are framed with bolder lines. In order distinguish the search results from one group to another, partitioning the display area, differentiating the color or size of the image frames, tagging indexes or marks, or any other appropriate method is applicable.

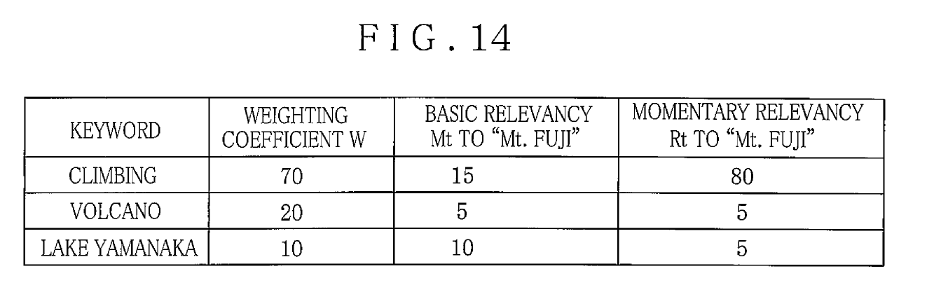

In the above embodiment, the basic relevancy AMt and the momentary relevancy ARt of a particular image to the search keyword are calculated by averaging basic relevancies Mt and momentary relevancies Rt of individual keywords of the particular image, respectively. If the keywords attached to the particular image are weighted differently from each other, it is preferable to calculate these values ARt and AMt by way of correspondingly-weighted average. If, for example, the individual keywords as shown in FIG. 7 are weighted with variable weighting coefficients W in a manner as shown in FIG. 14, the values AMt and ARt are calculated as follows:

AMt=(15×70+5×20+10×10)/100=12.5

ARt=(80×70+5×20+5×10)/100=57.5

Although the above described embodiment refers to images as the contents or search targets, the contents are not limited to images but may be movie data, music data, text data, computer software, Web pages and complex mixtures of these contents. The keywords attached to the individual contents are not limited to letters or characters but may be expressed by codes, numbers or the like.

Although the above embodiment calculates the inter-keyword relevancy on account that those keywords which are attached to the same content are relevant to each other, if several keywords are simultaneously entered as search keys, it is possible to calculate the inter-keyword relevancy on account that the simultaneously entered keywords are relevant to each other.

Thus, the present invention is not to be limited to the above embodiments but, on the contrary, various modifications will be possible without departing from the scope of claims appended hereto.

What is claimed is:

1. A contents-retrieving apparatus for retrieving some contents from a database on the basis of an entered search keyword, wherein said database stores variable contents with their respective keywords attached thereto, said contents-retrieving apparatus comprising:
an inter-keyword relevancy calculator for calculating an inter-keyword relevancy between every pair of keywords attached to the contents as stored in said database, said inter-keyword relevancy calculator calculating the inter-keyword relevancy at constant time-intervals to produce time-sequential data on the inter-keyword relevancy of every pair of keywords;
a basic relevancy calculator for calculating a basic relevancy of a particular keyword to the search keyword by smoothing the time-sequential data on the inter-keyword relevancy between the search keyword and said particular keyword;
a contents-extracting device for extracting at least a content from said database on the basis of the search keyword;
a judging device for making a judgment as to whether the extracted content should be included in a search result, said judging device making the judgment on the basis of the basic relevancy between the search keyword and a keyword which is attached to the extracted content; and
an outputting device for outputting the search result.

2. A contents-retrieving apparatus as recited in claim 1, wherein said inter-keyword relevancy calculator calculates the relevancy between each pair of keywords on the assumption that those keywords which are attached to the same content have some relation to each other.

3. A contents-retrieving apparatus as recited in claim 1, wherein said basic relevancy calculator smoothes the time-sequential data on the inter-keyword relevancy by moving average.

4. A contents-retrieving apparatus as recited in claim 1, further comprising a total relevancy calculator for calculating a total relevancy of a content to the search keyword when a plurality of keywords are attached to said content, said total relevancy calculator calculating the total relevancy by averaging the basic relevancies between the search keyword and the respective keywords attached to said content, wherein said result judging device judges the extracted content by its total relevancy.

5. A contents-retrieving apparatus as recited in claim 4, wherein said result judging device judges those contents, of which total relevancy is greater than a predetermined value, to be included in the search result.

6. A contents-retrieving apparatus as recited in claim 1, wherein said contents-extracting device extracts those contents which are attended by the search keyword from said database, and said basic relevancy calculator calculates the basic relevancies with respect to the extracted contents.

7. A contents-retrieving apparatus as recited in claim 1, further comprising a search command input device that allows designating a content among several contents and inputs a keyword attached to said designated content as the search keyword.

8. A contents-retrieving apparatus as recited in claim 1, wherein said contents are images.

9. A contents-retrieving method for retrieving some contents from a database on the basis of an entered search keyword, wherein said database stores variable contents with their respective keywords attached thereto, said contents-retrieving apparatus comprising steps of:
calculating an inter-keyword relevancy between every pair of keywords attached to the contents as stored in said database at constant time-intervals to produce time-sequential data on the inter-keyword relevancy of every pair of keywords;
calculating a basic relevancy of a particular keyword to the search keyword by smoothing the time-sequential data on the inter-keyword relevancy between the search keyword and said particular keyword;
extracting at least a content from said database on the basis of the search keyword;
making a judgment as to whether the extracted content should be included in a search result on the basis of the basic relevancy between the search keyword and a keyword which is attached to the extracted content; and
outputting the search result.

10. A contents-retrieving method as recited in claim 9, further comprising a step of calculating a total relevancy of the extracted content to the search keyword when a plurality of keywords are attached to the extracted content, the total relevancy being calculated by averaging the basic relevancies between the search keyword and the respective keywords attached to the extracted content, wherein the extracted content is judged by its total relevancy in said judging step.

11. A contents-retrieving method as recited in claim 10, wherein the total relevancy is calculated by weighted average of the basic relevancies of the keywords attached to the extracted content.
